(19) United States
(12) Patent Application Publication
(10) Pub. No.: US 2002/0072915 A1
(43) Pub. Date: Jun. 13, 2002

(54) Hyperspeech system and method

(76) Inventor: Ian L. Bower, Dallas, TX (US)

Correspondence Address: TEXAS INSTRUMENTS INCORPORATED, P O BOX 655474, M/S 3999, DALLAS, TX, 75265

(21) Appl. No.: 09/732,960

(22) Filed: Dec. 8, 2000

Related U.S. Application Data
(60) Provisional application No. 60/173,507, filed on Dec. 29, 1999.

(51) Int. Cl. G10L 21/00; G10L 11/00

(52) U.S. Cl. 704/270.1

(57) ABSTRACT

A method of speech browsing is described wherein Internet web pages with hyperspeech links and hyperspeech audible sounds and speech text is received for producing audible speech and hyperspeech link sounds. The method includes navigating down and up hyperspeech links in response to hearing the speech and hyperspeech link sounds using selector controls.

### FIELD OF INVENTION

This invention relates to a system that takes hypertext and moves it into speech.

### BACKGROUND OF INVENTION

In the present age, people are spending much of their time traveling more and longer distances even just to the place of work and are active in exercising, driving and working. At the same time, there is so much more information available and some of it necessary for work or play that there is little time to find it and read it. The Internet has made so much information available. It takes time to access information wanted while sitting at a terminal at home or in the office which further takes any other free time. It is highly desirable to provide some means by which one could access the Internet without sitting at a terminal or viewing a screen and while doing other activities such as driving to work or exercising. It is also desirable for the blind to have access to the Internet.

Other solutions for bringing information technology to the drive-time use the talking book model or the record player model. The Recording for the Blind and Dyslexic model use links, but only for Table of Contents and Index. Other models, such as Voice Extension Marking Language (VXML) use the call center model, with a list of options and processing number keys or recognition to drive choices.

### SUMMARY OF INVENTION

In accordance with one embodiment of the present invention, a system is provided that downloads content from the Internet including hypertext links. The system provides a menu as a home page with links that are made available by speaking out highlighted via a speech synthesizer in the system links. When the speech for the link or text the user wants is heard, the user notifies the system to take that link or text. The system provides hyperspeech in place of the hypertext.

### DESCRIPTION OF THE DRAWINGS

FIG. 1 illustrates a system for generating hyperspeech;

FIG. 2 is a portable system according to one embodiment of the present invention;

FIG. 3 illustrates a system with an MPEG player;

FIG. 4 illustrates a system with a PDA;

FIG. 5 illustrates a system with a PC; and

FIG. 6 illustrates a PC system with wireless interface.

### DESCRIPTION OF PREFERRED EMBODIMENTS OF THE PRESENT INVENTION

Referring to FIG. 1, there is illustrated a system 100 for generating hyperspeech. The text including hypertext is applied to a phonetic recognizer 101. The recognizer 101 generates templates. The templates are matched to the speech by time alignment at orthographic transcription of speech at alignment system 103 whereby pages, paragraphs and other divisions of the text are located in the speech. A code 105 is identified for the hypertext and is used to generate an audible sound for the hyperspeech associated with hypertext. This generator for hyperspeech could be done on a PC or workstation and stored on the web server. The stored speech and tone is stored in storage 108. If there is an error that can be noted or further processed according to selection at 110.

A system which given hypertext and speech corresponding to the text generates recognition templates and uses them to automatically link the text to the speech, generating any of the many standard forms of pointers to mark phonemes, words, phrases, sentences, paragraphs, links, pages or any other division of language as tied together—text to speech. This system could be derived from the system described in a Texas Instruments' patent, U.S. Pat. No. 5,333,275 of Wheatley et al. on orthographic transcription of speech, entitled “System and method for Time Aligning Speech,” incorporated herein by reference.

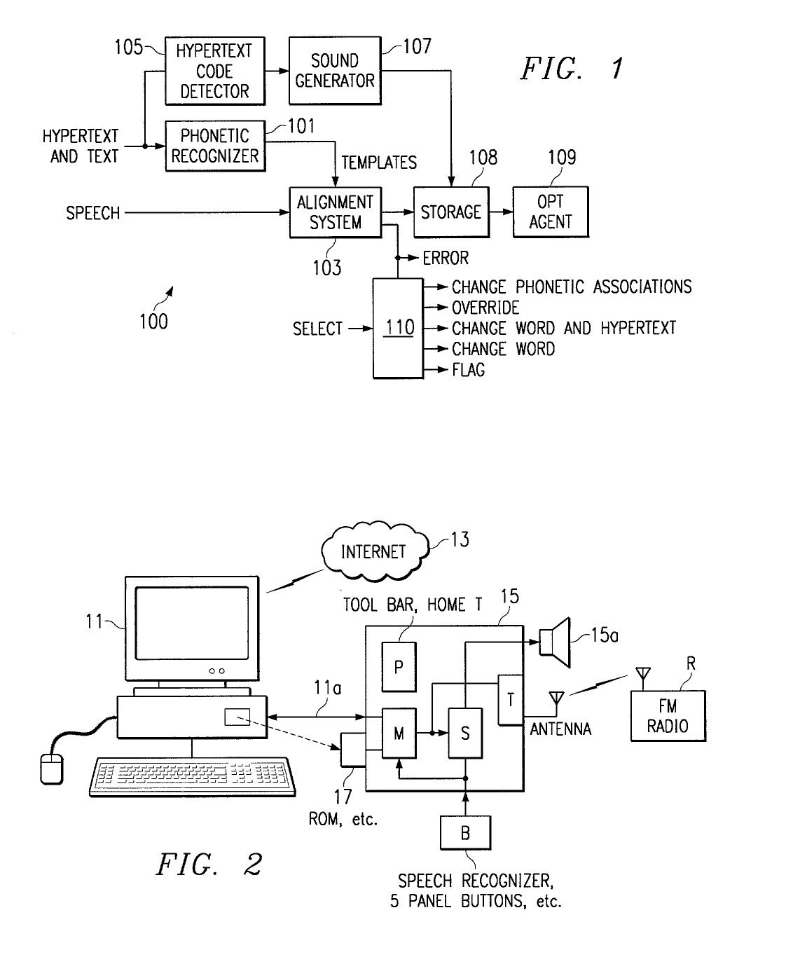

Referring to FIG. 2, there is illustrated the system according to one embodiment of the present invention. A personal computer (PC) 11 includes a browser, downloads content from the Internet 13. The PC 11 could receive the hyperspeech. The hyperspeech for the home page and link pages and the corresponding text for the day is stored. For example, if the CNN Network Internet pages are stored, the home page and all link pages are stored with the hypertext model. The PC 11 could be set up with an agent to receive only selected material from the web, for example. A portable, handheld device 15 receives the time aligned hyperspeech from the I/O port of the PC via lead 11a or in an alternative, receive the same via a memory disk to the personal computer 11 and that is plugged into the portable device 15. The portable device 15 includes memory M for storing this data, a speech synthesizer S for converting the speech pages to sound for the speaker 15a and hypertext codes to sounds and a processor P for controls and operation program. When the listener wants to select that link, a button B is pressed when the speech is heard followed by a hypertext sound or some other control is activated to select that link which is then played out of the speaker 15a. It may be another link spoken menu or the desired text. The CNN Network menu can offer news, sports, weather, horoscopes, mail, etc. When selecting the news link, for example, one hears an interesting headline followed by the hypertext code generated sound, one can select that headline by pressing the button B when the synthesized call out of “NEWS” is heard followed by a beep, for example. The system via the synthesizer S speaks the links or details of the story stored in the memory M. Just as a hypertext page, the user has the opportunity to go back up the chain of links back to news or the home page or one is able to pursue links until one runs out of information stored in the memory. The PC could include a compressor for compressing the speech before being sent to the portable device 15. The portable device 15 would have a decompressor for the speech.

The primary form of the handheld device 15 is similar to an Audible player with software and control differences. The device 15 would include a microprocessor, a Digital Signal Processor (DSP) for control and speech decompression. The memory M could be a flash memory and storing speech, text and program. The speaker 15a output could be a headset and the device include a headphone driver circuit. The downloading from a PC; the communicating of content and uploading to a PC can be via an RS 232 serial port, USB (Universal Serial Bus), any of various forms of RF (Radio Frequency) interface, any of various forms of IR (Infrared) interface, parallel interface, or even I394, if very high speed download is desired. The device might also be able to switch back to hypertext when returning to your PC at home or work. The hypertext is sent back to the PC or retrieved from PC storage.

Optionally, the output could be a loudspeaker, a speaker, a small FM transmitter T to play through an FM radio R, an RF (radio frequency) or IR receiver to support a remote RF or IR keypad for mounting elsewhere, such as on a steering wheel of a car, or somewhere else for ease of use.

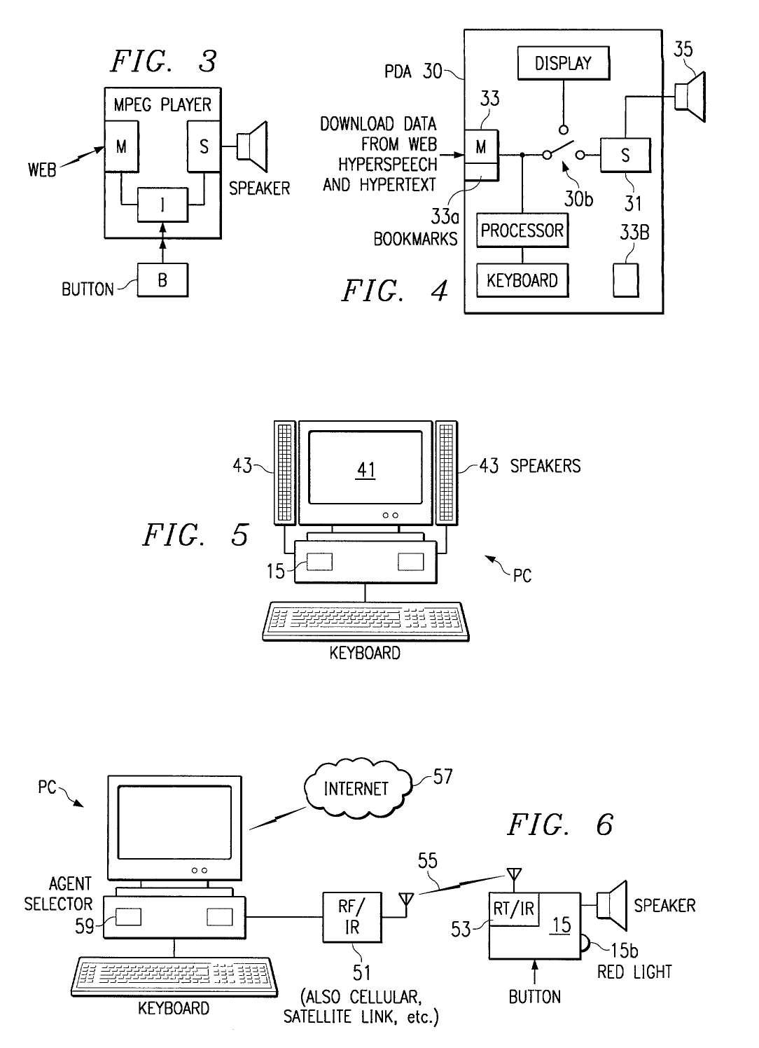

The product could be as simple as offering an audio guide through current selections on an MPEG (Moving Pictures Experts Group) player as shown in FIG. 3. The MPEG is a known lossy compression method. The MPEG player could start by playing speech giving titles of all selections on the player, and when the one the user wants is spoken, the user plays that one by pressing a button to make a selection.

For a low end, low cost system, the data can be stored in a masked ROM, either integrated with the device 15 or in a removable cartridge 17. For data that a large number of people wanted, a ROM cartridge would also reduce cost over use of a flash cartridge illustrated in FIG. 2. The memory M can also be any of the other forms of volatile or non-volatile memory including, but not limited to, SRAM, DRAM, ARAM, ferroelectric RAM, magneto-optical disk, mini-disk, CD-ROM, DVD, tape based storage, magnetic disk, etc.

Other forms basically involve integrating the functionality of the device with existing devices. It could be integrated into a Personal Digital Assistant (PDA) 30 as illustrated in FIG. 4. The PDA is a handheld computer like “Palm Pilot” that serves as an organizer for personal information. Depending on the processing power of the PDA, a DSP with synthesizer 31 may be required for speech playback. The PDA's existing memory 33 could be used for hyperspeech/text storage, or additional memory could be provided. If PDA does not have playback means, such as headphone outputs or a speaker 35, they could be provided by an add-on. Hyperspeech data could be downloaded directly from the web, or via a PC or other intermediary. With a PDA, the web browsing can switch back and forth from hypertext to hyperspeech on the fly by switch 30b. Possibly with as simple a thing as a button 30B, either physical or virtual. In this way, one could switch from using the PDA for hyperspeech, for example, when exercising or doing housework, to typing in characters using keyboard and display for a search, back to listening to the search results in hyperspeech mode, while going back to exercising. One could also do hypertext until it was time to start driving, drive to wherever one was going listing to the hyperspeech, and then switch back to hypertext again. With all these switches, things like bookmarks 33 or recently visited link flagging, and so on, are be preserved in memory 33.

The hyperspeech system could be added to a PC as illustrated in FIG. 5 with device 15 connected to the I/O bus and have the hypertext displayed in display 41 (or not) as the speech is played out of speakers 43. On a PC, software would have to be added to decompress the speech, if it is compressed, and to decode the links between the speech and the hypertext, and to correlate the display of the text with the playback of the speech. Memory, I/O, and processing power would probably be sufficient with no enhancement. Software would be added to allow the hypertext display to control the hyperspeech playback and vice versa. All of the functionality described above in the PDA 30 above could also be implemented as above.

The next form is a PC with a wireless—RF or IR or other interface—hyperspeech remote 15. See FIG. 6. The PC would include an RF or IR transceiver 51 and the remote 15a matching transceiver 53. All the PC functionality above could be provided, with additionally a remote, comprising keys similar to the ones described below, as well as a means (speaker, synthesizer, etc.) of playing received audio/speech. These would be interfaced real-time to the PC via the RF or IR link 55. This device would function much like the first device described above, except that the content would be on the PC, immediately downloaded from the Internet 57. As long as you were in range of the PC, you could access all hyperspeech on the Internet.

A device combining the functionality of the first PC device, and the PC with a wireless interface. When in range of the PC, one could communicate with the PC directly. When not in range, it would use stored data that had been downloaded earlier. It could have an agent selector 59 that attempted to anticipate what data you wanted to have based on your requests, and your download history. This agent could run at the same time as one was interacting with the PC, and could download data to meet one's anticipated needs at the same time as it was downloading data for one's current real-time requests. The agent picks out the hypertext pages recorded of interest only by selection or by last read group of links. It could be certain stocks, news items, etc.

Since much of the demand for this device is for drive time, a version of the initial device could be integrated with an automotive entertainment system—radio, cassette player, CD player, auto video system, navigation system, etc. The data communication could take place in many ways—RF or IR directly to the user's PC. A short range IR or RF link could be installed in the user's garage or parking space, connected to the user's PC, that would interface to the automotive version of the hyperspeech appliance. A longer range IR or RF link could be used for larger parking areas, still directly connected to the PC. A third party RF link, such as cellular telephone, broadcast radio, satellite, or data network, could also be used, with data selection done by third party, user's commands from a PC or other source, or from user's commands from the appliance itself. A simply physical connection, for example, a USB bus, or one of the buses described above could also for the connection. A flash cartridge, programmed somewhere else could be plugged into the automotive hyperspeech appliance. Some parts of the hyperspeech appliance could be included with the flash cartridge as well. All of the aforementioned connection methods could also be used to get usage information on which pages were actually read, as well as other information generated by the use of the hyperspeech appliance back to the user's other data access devices, or to third parties.

The hyperspeech device could also be integrated with an MPEG 3 or similar audio player, since such a player would have all the DSP and memory capability required, and would just need programming, and possibly user interface enhancements.

Any of the devices described above could also have a real-time, wireless connection to the Internet or to some other data source, overcoming the limitations imposed by a limited storage capability on the device itself.

The system described in connection with PC could have automatic marking of places where the recognition templates generated from the text do not match the speech. See FIG. 1. For example, any word in the text that does not fit the recognition template within an adjustable threshold (error) can be highlighted in red on the PC or workstation. The user could hit a key or mouse command to go to the next unrecognizable word, which will be displayed on the screen with the text around it. On command, the speech including the unrecognizable word can be played. The user could be offered multiple correction choices, including, but not limited to:

changing the phonetic assumptions for that word for the recognizer, and re-running the recognition,

overriding the recognizer and telling it that the text is correct,

changing the word in both the text and the hypertext,

leaving the hypertext the same and changing the word for the recognizer, and

flagging the speech for re-recording.

The system could also have transcription checking, where it plays the speech and simultaneously highlights the word in the text where it matches the speech. It could do this at full speed, or faster or slower, and with or without pauses between each word. Or it could play a word or segment every N words or N seconds, where N is a number between 0 and say 1000 or more, as a spot check. Or it could only permit evaluation of the sections around the links or other major divisions of the speech, especially if these are the only points at which the speech is tied together. This system could work from speech encoded in many different forms, including all the standard straight audio formats as well was with coders, including perceptual and voice type coders. The system could code the speech into a new form selected from any of the above forms and add the pointers to that, or leave the speech in its original form and add the pointers to that. This system could also be used to drive the phoneme source for a phonetic vocoder encoding the speech, including using all the corrections described above. Provision will have to be made in the system for speech descriptions of pictures/video, maps, etc., visual content. It may necessary, during the recording session to flag some sections as not tied to the hypertext, but as corresponding to an image or other input. If a phonetic vocoder is being used, or to facilitate searching of the text, it may be necessary to enter text corresponding to the description of the picture. Other descriptions of other non-spoken aspects of the page, such as background, animation, borders, typeface, equations, etc., can also be added. If there is spoken audio included in the page, it can be attached to the hyperspeech file, either in the same or a different coder, with or without text attached as described above. The system will, of course, need to analyze the hypertext to see what will appear as text and what will not. The recording script should be generated from output generated from that program, rather than only from a reading of that page. For example, the program will need to develop a standard arrangement for deciding which text goes before which text, for example, with tables and with text which is arranged in non-obvious order. Options can be provided for the page designer or the speech recording person to rearrange the standard order as required for the specific page. Audio, non-voice content can be attached, compressed or non-compressed, possibly with a text description, which could also be attached as spoken data before or after the audio.

The system could also include, tied to the speech, information about which speech corresponds to a hyperlink. Hyperlinks are normally shown in hypertext by blue text, which turns to purple if the link has been taken in the recent past. On the proposed system, links could be indicated by various acoustical cues, including:

beeps, clicks, and other distinguishable sounds before and/or after the speech for the hyperlink;

a background tone during the link; and

a change in pitch and/or amplitude and/or speed of the speech during the link.

A visual indication, for example, an LED illuminating as illustrated by 15b in FIG. 6. Speech before and/or after the link, for example, “linkstart” before the link and “linked” after from the speaker of unit 15. Short, easily distinguished speech tokens would be best, for example, an “ah” before, and “mm” after. These tokens could be inserted by the reader as the text is read for the speech source, and the speech to text linking system described above could be programmed to look for them. All of these acoustical cues could be user selectable at the time of listening by programming the playback device. Different cues could be set up for links which have been taken recently, and for those which have not been taken recently, similar to the blue and purple on the hypertext system. Other cues are needed for end of page and start of page. The system could wrap around at the end of the page, and start from the beginning again, or stop there. It could also, in the case of sequential pages, be programmed, either dictated by the page writer, or by the recording person, to go automatically to the next page in the sequence. There are many sequential web pages, normally with a button on the bottom that says “next page.” A standard could be developed that could be automatically processed by a hyperspeech system. Other links, such as buttons, could be indicated in the same way as standard hyperlinks, possibly preceded by an additional token, such as “Button.” Links like maps could be devolved into speech components, such as reading the names of the states for a map of the U.S. Or special “speech friendly” hypertext could be used for this type of application.

The system could be controlled by various means, including speech recognition substituted for button B in FIG. 2. The simplest control would be with a panel with five buttons. They would be called.

Link Forward;

Link Back;

Speech Forward;

Speech Back; and

Toolbar.

As described above, the speech speaks. When a hyperlink that you want is played, you press the Link Forward button and the speech for that hyperlink starts. This is roughly equivalent to clicking on the link with a mouse. As the speech for the first hyperlink goes, additional links can be taken in the same way, ad infinitum. It is also possible to press the Link Back button at any time. This would take the user back up to the previous link, similar to the back button on a browser toolbar. The Speech Forward and Speech Back buttons would correspond to the mouse movement on a hypertext system. Since speech is only one dimensional, they could go back and forward in time. These buttons could work in many ways. The could go move faster and faster in time the longer they are held down. During the movement, they could play back parts or all of the speech, either at normal speed or sped up. Speech could also be played back saying how many seconds, minutes, or hours they had bone back or forward. A double click, or separate buttons, could be used to move back to the previous hyperlink, or forward tot he next hyperlink, or to other logical steps on the “page.” These two buttons could be pressure or position sensitive, with more pressure leading to faster movement.

The final button, the “Toolbar” button T (see FIG. 2), is used to control the device, and to permit access to other system functions. It would, when pressed, offer access to the tools speech menu. Tools could include all the other functions provided on the toolbar of a hypertext browser that make sense. All of the functions could be spoken, something like the hyperlinks, with the function selected if the link forward button is pressed. “Home” would be a key function. “History,” “Bookmarks,” etc., would also be useful, with History and Bookmarks offering the option of reading out the titles of the pages listed in the corresponding lists, and hyperlinking to the pages directly. Bookmarks could also offer the option of adding the current page to the bookmarks. Other toolbar functions should be specific to the device—functions like volume control adjustment, speech speed adjustment (the playback could be sped up or slowed down) are device control functions that could be on the basic toolbar menu, or reached from a device control toolbar “button.” Other specific toolbar functions could be to mark specific hyperspeech files for deletion, or for retention, with unmarked files left up to the discretion of whatever agent is running on the device and on any data source device. It would, of course, be possible to move any and/or all of these functions to specific buttons or other controls on the device.

One version of the device could work with a user controlled agent on the PC, where the user requests specific files, and/or describes the types of files they want to have downloaded. The files will then be downloaded from the web onto the PC, and then onto the hyperspeech device. A daily news/personal interest service could be provided, similar to the My Yahoo page, for example, but with hyperspeech. The user inputs their preferences, which are updated based on information about what pages they actually access. The agent in the PC, or at the internet site, decides, based on this information, what to download at a given time.

Advertising could be inserted into the hyperspeech flow by advertisers, much as banner advertising is used on hypertext. The advertisement could be a speech/audio segment of any duration, with hyperspeech links as described above inserted in it, and with additional content available for the user to explore the content of the ad further, if desired. Like all transactions on the device, these could be recorded and sent back to the host server on the internet for use in further advertising targeting. Data could also be derived from television scripts combined with their closed captioning material, if desired, for the text component of the hyperspeech. 1Broadcast radio source material could be treated in a similar manner. The hyperspeech device could have a local audio recording capability added for a variety of purposes. For general recording of reminders, telephone numbers, and other things which would normally be written down, but which would need to be recorded in the hands-free environment in which the device is most often used. Reminders attached, for instance, to links or pages describing what the user thought or needs to do with the link or page. Voice mail based on the page. The hyperspeech device could also be used to receive voice mail, recorded on the PC or other hose, or sent to the PC or other host from a voice mail client elsewhere, or sent directly to the device. The voice mail could be summarized in a hyperspeech format—with the sender's identity and/or a voice description of the subject played out as hyperspeech links, with an option to jump to those links and hear the message. Time/date stamping and message duration could also be provided in hyperspeech format as well.

What is claimed:

1. A method of speech browsing comprising the steps of:
receiving Internet web pages with hyperspeech links with hyperspeech audible sounds and speech text for producing audible speech and hyperspeech link sounds from said hypertext links and text; and
navigating down the hyperspeech links and back up the hyperspeech links in response to hearing the speech and hyperspeech link sounds.

2. The method of claim 1, wherein the receiving step includes the step of downloading the Internet pages with hypertext.

3. The method of claim 1, wherein the reviewing step includes the step of time aligning speech with text and generating sounds related to hyperspeech locations related to hypertext locations.

4. The method of claim 2, wherein the step of downloading includes the step of downloading from a PC.

5. The method of claim 1, wherein the receiving step includes a memory for storing the hyperspeech web pages and hypertext related sounds associated with hyperspeech and a speech synthesizer for producing speech and sounds.

6. The method of claim 5, including a speaker for producing sound.

7. The method of claim 5, including headphones for hearing the synthesized sound.

8. The method of claim 5, including a transmitter for transmitting the synthesized sound.

9. A speech browser comprising:
a receiver for receiving Internet web pages with hyperspeech links and speech text that is time aligned with hypertext and text;
a speech generator for producing audible speech and hyperspeech link sounds from said hyperspeech links and speech text;
a navigator selector for selecting the up and down links in response to hearing the speech from hyperspeech command links and link sounds.

10. The speech browser of claim 9, wherein said receiver receives a downloaded Internet pages with coding of hypertext with aligned speech.

11. The speech browser of claim 10, wherein said speech generator includes a speaker.

12. The speech browser of claim 10, wherein said speech generator includes headphones.

13. The speech browser of claim 10, wherein said speech generator includes a radio transmitter modulated with the speech signals for transmitting to a remote receiver that plays the speech.

14. The speech browser of claim 13, wherein said remote receiver is a radio.

15. The speech browser of claim 10, wherein said selector includes a switch button.

16. The speech browser of claim 10, wherein said selector includes a speech recognition system for responding to spoken speech commands to providing the link selections.

17. The speech browser of claim 9, wherein said receiver includes a memory for storing web pages.

18. The speech browser of claim 17, wherein said receiver includes a connection network for receiving web pages downloaded from the Internet.

19. The speech browser of claim 9, wherein said receiving means includes a removable memory storage containing the web pages.

20. The speech browser of claim 9, wherein said receiver includes a connection network to receive downloads from a PC.

21. A PDA comprising a PDA system with a speech browser of claim 9, wherein said receiver includes the memory of said PDA is used for hyperspeech text storage.

22. The browser of claim 9, wherein the receiver includes a wireless network interacting with the PC to download the Internet pages.

23. The browser of claim 13, wherein said remote receiver is an automobile radio system.

24. The browser of claim 13, wherein said receiver includes a card memory reader.

25. The browser of claim 9, integrated with an MPEG 3 or similar audio player.

26. A method of speech browsing comprising the steps of:
first generating speech time aligned with text with pointers marking divisions of text;
second, generating code signals time aligned with hypertext;
receiving said time aligned speech and code signals;
generating audible sound with speech time aligned with hypertext; and
navigating down and up the links in response to hearing the speech.

27. The method of claim 26, wherein said first and second generating steps generate recognition templates for linking text to the speech, generating pointers to mark phonemes, words, phrases, sentence, pages or other divisions of language.
